(19) United States
(12) Patent Application Publication
(10) Pub. No.: US 2023/0413033 A1
(43) Pub. Date: Dec. 21, 2023

(54) DEVICE COMPRISING A SUBSCRIBER IDENTITY MODULE INTERFACE AND ASSOCIATED METHOD

(71) Applicant: SAGEMCOM ENERGY & TELECOM SAS, Rueil Malmaison (FR)

(72) Inventors: Pierre LHUILLIER, Rueil Malmaison (FR); Patrick GINESTET, Rueil Malmaison (FR)

(21) Appl. No.: 18/335,908

(22) Filed: Jun. 15, 2023

(30) Foreign Application Priority Data
Jun. 16, 2022 (FR) 2205869

(51) Int. Cl. H04W 8/18

(52) U.S. Cl. CPC H04W 8/183; H04W 88/06

(57) ABSTRACT

The invention relates to a device comprising an interface for subscriber identification module, a first subscriber identification module connected to said interface; a connector suitable for connecting a second subscriber identification module to said interface when the second module is present in the connector; a presence detector configured to generate a presence signal of the second module in the connector; an inhibition circuit for inhibiting the first module according to the presence signal, the device being configured to operate with the second module when the first module is inhibited, the inhibiting circuit being configured to inhibit a module by setting a data input/output of said module to a high impedance state, by applying a signal corresponding to an active state to an initialization signal input of the module to be inhibited. The invention also relates to a method, a computer program product and a program storage medium.

### CROSS-REFERENCE TO RELATED APPLICATIONS

The present application claims priority to French Application No. 2205869 filed with the Intellectual Property Office of France on Jun. 16, 2022, which is incorporated herein by reference in its entirety for all purposes.

### TECHNICAL FIELD

A device is described comprising a subscriber identity module interface configured to manage multiple subscriber identity modules, as well as a corresponding method. The technical field comprises but is not limited to devices, such as, for example, meters, connected to a communication network.

### TECHNICAL BACKGROUND

There are many devices comprising a subscriber identification module (commonly referred to as “SIM” module), this type of module being necessary for devices to access a communication network. In some applications, a module of this type is fixed, for example by soldering, to a printed circuit board of a device in a way that makes it difficult to remove. When the device has only one interface for such a module, it is complicated to install a second module—it is necessary, for example, to desolder the original module and replace it with the second module. A solution allowing easier use of a second module is desirable.

### SUMMARY

One or more embodiments relate to a device comprising:
an interface for a subscriber identification module;
a first subscriber identification module connected to said interface;
a connector suitable for connecting a second subscriber identification module to said interface when the second module is present in the connector;
a presence detector configured to generate a presence signal of the second module in the connector;
an inhibiting circuit for inhibiting the first module according to the presence signal, the device being configured to operate with the second module when the first module is inhibited, the inhibiting circuit being configured to inhibit a module by setting a data input/output of said module to a high impedance state, by applying a signal corresponding to an active state to an initialization signal input of the module to be inhibited.

According to one embodiment, the device includes
a data bus interconnecting a data input/output of the interface, the input/output of the first module and an input/output of the connector which cooperates functionally with a data input/output of the second module when the second module is present in the connector;
a clock signal bus interconnecting a clock signal output of the interface, a clock signal input of the first module and an input of the connector which functionally cooperates with a clock signal input of the second module when the second module is present in the connector.

According to one embodiment, the inhibition circuit comprises a circuit controlled by the presence signal to automatically inhibit the first module when the second module is present in the connector, the device then operating with the second module via said interface.

According to one embodiment, the circuit is controlled by the presence signal to automatically disinhibit the first module when the second module is removed from the connector, the device then operating with the first module via said interface.

According to one embodiment, an initialization signal output of the interface is connected to a first input of the connector, the connector being suitable for connecting the first input to an initialization signal input of the second module when the second module is present in the connector; a resistor is connected between the initialization signal input of the second module and the initialization signal output of the interface, the resistor being suitable for allowing said interface to
control an initialization of the second module when it is present in the connector and the first module is inhibited; and
control an initialization of the first module when the second module is not present in the connector and the first module is not inhibited.

According to one embodiment, the inhibiting circuit comprises a processor receiving the presence signal, the processor being configured to selectively inhibit and disinhibit, respectively, one of the first and second modules, and to disinhibit and inhibit, respectively, the other one of the first and second modules, when the second module is present in the connector, the device being configured to operate with the disinhibited module.

According to one embodiment, the processor is configured to implement at least one of:
a first mode wherein the first module is automatically inhibited in the case where the second module is present in the connector and automatically disinhibited in the case where the second module is removed from the connector;
a second mode wherein, when the second module is present in the connector, the first module is inhibited following receipt of a confirmation from a user and disinhibited automatically if the second module is removed from the connector, or on receipt of a command from a user.

One or more embodiments relate to a method implemented by a device comprising an interface for a subscriber identification module; a first subscriber identification module connected to said interface; a connector suitable for connecting a second subscriber identification module to said interface when the second module is present in the connector; a processor and a memory including software code which, when it is executed by the processor, causes the device to carry out the method, the method comprising:
detecting the presence of the second module in the connector;
inhibiting the first module according to the presence signal; and
when the first module is inhibited, operating the device with the second module,
   the inhibition comprising setting a data input/output of the module to be inhibited to a high impedance state, by applying a signal corresponding to an active state to an initialization signal input.

According to one embodiment, the method comprises selectively inhibiting and disinhibiting, respectively, one of the first and second modules;

disinhibiting and inhibiting, respectively, the other one of the first and second modules; and operating with the module disinhibited.

One or more embodiments relate to a computer program product comprising instructions which, when the program is executed by a processor of a device, causes the device to carry out the described method.

One or more embodiments relate to a storage medium readable by a device provided with a processor, said medium comprising instructions which, when the program is executed by a processor of a device, causes the device to carry out the described method.

### BRIEF DESCRIPTION OF THE FIGURES

Further features and advantages will become apparent from the following detailed description, which may be understood with reference to the attached drawings in which:

FIG. 1 is a functional block diagram of a device according to a first non-limiting embodiment;

FIG. 2 is a flowchart of a method for implementing the device of FIG. 1 according to a non-limiting exemplary embodiment;

FIG. 3 is a functional block diagram of a device according to a second non-limiting embodiment;

FIG. 4 is a flowchart of a method for implementing the device of FIG. 3 according to a non-limiting exemplary embodiment.

### DETAILED DESCRIPTION

In the following description, identical, similar or analogous elements will be referred to by the same reference numbers. Unless otherwise indicated, the diagrams are not necessarily to scale.

The block diagrams and flowcharts in the figures illustrate the architecture, functionalities and operation of systems, devices, methods and computer program products according to one or more exemplary embodiments. Each block of a block diagram or each step of a flowchart may represent a module or a portion of software code comprising instructions for implementing one or more functions. According to certain implementations, the order of the blocks or the steps can be changed, or else the corresponding functions can be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller leads the system or device to implement all or part of the functionalities of the blocks and/or steps of the processes or methods according to the exemplary embodiments. The software code can be stored in a memory or a readable medium accessible directly or via another module by the processor or controller.

According to one or more embodiments, a device comprises a subscriber identification module interface. Several subscriber identification modules are connected to this interface. In operation, the device is provided to inhibit all but one of these modules. The interface then makes it possible to communicate with the active module, that is to say, the non-inhibited module.

Purely by way of illustration, the device is for example a device that requires a connection to a communication network, such as a cellular network. Such a network may require the use of a subscriber identification module to access the services. The device is for example a smart meter for electricity, water, gas . . . .

According to one or more embodiments, a data signal input/output and a clock signal output of the interface are connected to the modules and the related signals are sent to all the modules. The device is configured so that an initialization signal output of the interface can be forced to a given voltage level for the modules to be inhibited, this voltage level implying that the input/output of the data signal of these modules is set to a high impedance state, which corresponds to an inhibition. Only the module that must be active is not inhibited.

Inhibition may, according to some embodiments, be produced by a purely hardware assembly, or by the combination of a hardware assembly and appropriate software.

In the following, the case of two subscriber identification modules will be considered. According to one or more embodiments implementing management using a hardware assembly, a first module already having been connected to the interface, the second module being added subsequently, the detection of the presence of the second module (for example a module inserted removably into a connector connected to the interface) will generate the production, by an appropriate hardware assembly, of a signal at the given voltage level mentioned hereinbefore on the initialization signal input of the first module. According to one or more embodiments implementing combined hardware and software management, a component (for example a microcontroller) will be controlled by software so as to produce an appropriate signal on the initialization signal input of the module selected to be inhibited.

In some implementations, one module may have different or additional functionalities relative to the other module.

The use of the second module may be necessary for example in the following use cases:
A test with a network simulator or a test tool, the second module then being a SIM card dedicated to this test.
A connection to a network that cannot be accessed with the first module, for example in the context of validation or certification tests of the device and wherein the second module provides access to this network.
An assessment aimed at determining the cause of an incorrect operation (determining whether it is a network problem; a fault in the subscriber identification module or in the component controlling this module, etc.) without having to desolder and then, if necessary, resolder the first module.
A comparative test of the first and second modules.
In the case where a device is equipped with two SIM card interfaces, the second interface can have functionality limitations, compared with the first interface, the advantage then being to be able to connect the first and second modules to a single interface and to be able to test the two modules under the same conditions. The embedded software of the device can also take into account only one module in the case of normal use.

The device according to one or several embodiments makes it possible to avoid having to remove the first module in order to replace it with the second module, which could require desoldering the first module and soldering the second module, or even soldering a connector wherein the second module or a card carrying the second module can be inserted. If necessary, the first module should be put back into place at the end of the test. This could result in degradation of the first module, of other components of the device or even of the printed circuit board, following repeated manipulations.

According to one or several embodiments, the switching between modules can be carried out automatically, for example by detecting the presence and/or absence of the second module, or alternatively require one or more actions of a user, for example one or more enabling or disabling actions. These two embodiments will be described separately.

The first module is for example typically a SIM module that is intended to be fixed in the device. “Fixed” means that the first module is not intended to be removed from the device in a normal operating context. For example, the first module is soldered onto a printed circuit board of the device, or else to a suitable support in the device, during the manufacture of the latter. This may prevent the first module from being inadvertently removed. In another context, the first module can be removed from the device, but this is not desirable for certain reasons. For example, in the case of operating problems of the device, the fact of removing the first module may prevent or disrupt tests performed to determine the cause of the problems.

The first module is for example of the “eSIM” type, that is to say a discrete component that can be directly soldered onto a printed circuit board or onto a suitable support of the device, but the first module can also be placed on a support to form a microprocessor card, for example of the “MiniSIM”, “MicroSIM” or “NanoSim” type or else a conventional microprocessor card with the size of a credit card, and be inserted onto an appropriate connector of the device.

The second module is for example placed on a support to form a smart card that is easy to handle, for example of the “MiniSIM”, “MicroSIM” or “NanoSim” type or else a conventional smart card with the size of a credit card. However, it is not ruled out that the second module be of eSIM type.

### First Embodiment

According to the first embodiment, the first subscriber identification module is inhibited by a suitable hardware assembly. Hardware management of the inhibition of the first subscriber identification module makes it possible to rule out, or at least limit, the necessary adaptations to the embedded software.

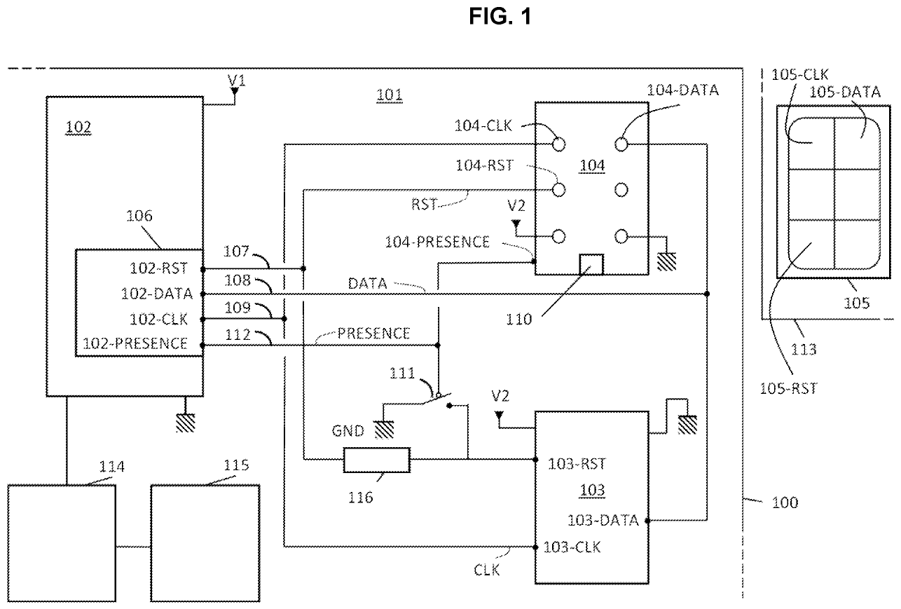

FIG. 1 is a functional block diagram of an example of a device 100 according to a first embodiment. The device comprises a printed circuit board 101 including a component 102, a first subscriber identification module 103 and a connector 104 suitable for connecting a second subscriber identification module 105.

The component 102 comprises an interface 106 for a subscriber identification module provided with several inputs and/or outputs for communicating on the one hand with the first module 103 or, when it is connected via the connector 104, the second module 105. According to the present exemplary embodiment, the component 102 is a modem, but another type of component can be used to control the subscriber identification modules via an appropriate interface, according to the envisaged application. For example, the component 102 may be a microcontroller. When the component 102 is a modem, the latter communicates with a subscriber identification module in order to be able to access the services of the communication network to which the subscription provides access.

The device is configured so that inserting the second module 105 into the connector has the effect of inhibiting the first module 103, thus allowing the component 102 to interact with the second module 105 via the single interface 106 for a subscriber identification module of the component 102. The second module 105 can be placed on a support 113 in order to be easier to handle, the whole forming a card with a subscriber identification module or SIM card.

The interface 106 of the component includes a bidirectional data input/output 102-DATA, an initialization signal output 102-RST and a clock signal output 102-CLK. The first module 103 comprises a bidirectional data input/output 103-DATA, an initialization signal input 103-RST and a clock signal input 103-CLK. The connector 104 includes an input/output 104-DATA, an input 104-RST and an input 104-CLK which, when the second module 105 is inserted into the connector, are connected to the corresponding contacts of the second module, 105-DATA, 105-RST and 105-CLK, respectively. Lines RST, DATA and CLK of the printed circuit board 101, with references 107, 108 and 109, respectively, connect the respective inputs and/or outputs of the component 102, of the first module 103 and of the connector 104. A resistor 116 is inserted between the initialization signal output 102-RST of the component 102 and the initialization signal input 103-RST of the first module.

Optionally, the signal indicative of the presence of the second module generated by the connector 104 reaches the component 102 via a line 112 connected to an input 102-PRESENCE of the interface 106 of the component 102.

The connector 104 includes, in a known manner, other contacts necessary for the operation of an inserted module (supply voltage, ground, etc.) which will not be detailed herein.

The device inhibits the first module 103 when the second module 105 is detected in the connector 104 by means of an appropriate assembly. According to the embodiment of FIG. 1, in the event of detecting the second module, the inhibition comprises setting the data bus of the first module to a high impedance state. In the context of the present example, the behavior of a module in the event of applying a low level signal to the initialization signal input is that the data input/output of this module is set to high impedance. The process for initializing a module is triggered by a rising edge on the initialization signal input; however, as long as a low level signal is maintained on the initialization signal input, the data input/output of the module remains in high impedance. The first module is thus inhibited, without having to be removed—the first module may especially remain connected to the clock signal line and to the data line.

The connector 104 comprises a module presence detector 110 which, when the second module 105 is inserted into the connector, generates a signal indicative of the presence of the second module in the connector (output 104-PRESENCE). According to the present embodiment, this signal is low when a module is present and high in the opposite case. The presence detector can take different forms, for example it may comprise in a manner known per se a simple limit switch which closes when the second module is completely inserted into the connector.

In the active state (low), the signal indicative of the presence of the second module in the connector closes a switch 111. In the closed state, the switch 111 connects a voltage representative of a low level (voltage at 0V, ground) to the initialization signal input 103-RST of the first module 103. In the open state, the output of the switch to the initialization input 103-RST of the first module is in high impedance.

When the second module is not inserted into the connector, the switch 111 is in a state wherein the initialization signal generated by the component reaches the first module via the resistor 116. When the second module is inserted, the switch 111 forces the initialization signal input 103-RST of the first module to zero. However, the presence of the resistor 116 prevents a signal generated by the component 102 at the initialization signal output 102-RST from being forced to zero. The resistor 116 is dimensioned accordingly—in a particular implementation, it is for example 2.2 kOhms.

Other hardware implementations for forcing the initialization signal input of the first module to zero when this first module must be inhibited may of course be envisaged by a skilled person, without the resistor 116. For example, it is possible to implement a single dual input/output switch having as first input a voltage source at the active voltage of the initialization signal input 103-RST of the first module and as second input the signal 102-RST of the interface of the component 102, and as output the initialization signal input 103-RST, the switch being controlled by the presence signal 104-PRESENCE of the connector 104.

The device according to the embodiment of FIG. 1 also comprises a processor 114 and a memory 115 including software code configured to allow the operation of the device as described. The memory 115 comprises for example the code of an application software executed by the processor 114.

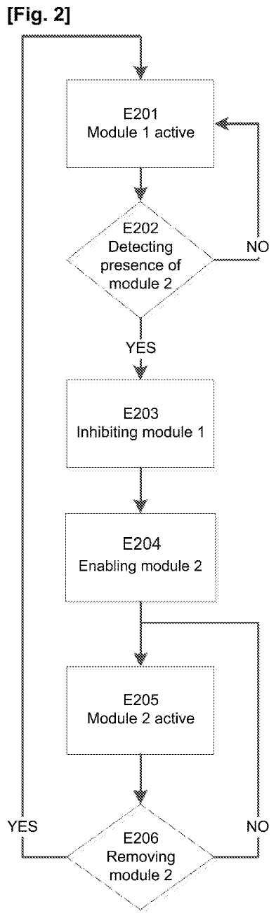

FIG. 2 is a flowchart which details an example of operation of the device of FIG. 1. According to this example, in E201, the device 100 operates with the first module, which is active. The initialization signal input 103-RST is not forced into its active state by the assembly controlled by the presence signal of the second module generated if necessary by the connector 104. In the absence of the second module, the first module is not inhibited. The component 102 controls the first module via its interface 106. This situation persists as long as no module is inserted into the connector 104 (E202 test negative). When the presence of the second module is detected (E202 test positive), the first module is inhibited. In E203, the initialization signal input 103-RST is then forced into its active state (low signal in the present example) by the assembly controlled by the presence signal of the second module, resulting in the data input/output of the first module being set to high impedance and thus in the inhibition of this first module. The second module is fully connected to the component 102 by the interface 106 and the component 102 can communicate with the second module and especially enable it (E204) by performing an initialization. The device then operates with the second module (E205). This situation persists as long as the second module is not removed from the connector 104 (negative test in E206). If the second module is removed (positive test in E206), then the presence signal changes state and the first module becomes active again (E201).

According to the present embodiment, the component 102 does not use the presence signal generated by the connector 104 to manage the subscriber identification modules. The component 102 may optionally use this signal to manage a removal/reinsertion of the first module when the device is powered on, in the case where the first module can be extracted.

The component uses a protocol which allows it to switch from one module to the other.

Two cases are to be considered, taking the example wherein the component 102 is a modem:
(a) The second subscriber identification module was inserted when the device was powered down.
   a.1. When the device is powered on, the first module is automatically inhibited with the switch 111 controlled by the presence signal of the second module.
   a.2. The application software initializes the modem (the component 102 according to the present example).
   a.3. Once the modem has been initialized, the application software queries the modem to know the state of the subscriber identification module connected to the interface of the modem, in this case the second module. The modem indicates in return whether the module is operational, whether it is blocked, whether a PIN or PUK code is necessary, or whether there is no subscriber identification module.
      If the second subscriber identification module is operational, the modem can, using the information contained in the second module (identifier of the operator, network, roaming, etc.) connect to the identified communication network and operate normally.
      If no module is detected (for example if the second module is defective, or else if a printed circuit board connected to a remote connector of a remote module is inserted into the connector 104, without a module having been inserted into the remote connector), the application software restarts the initialization of the component 102 until a module is detected (points a.2. and a.3. hereinbefore).
   a.4. When the operation with the second module is no longer useful, the device is powered off, the second module is removed and if necessary the device is powered up again.
(b) The second subscriber identification module is inserted when the device is powered on (so-called “hot” insertion).

The application software will then have already previously performed the initialization sequence of the modem, which is in a normal operating mode, namely it is optionally connected to a network based on the information contained in the first module.

b.1. Following the insertion of the second module, the first module is automatically inhibited by controlling the switch 111 by the presence signal of the second module.

b.2. The modem (component 102) detects that communication with the first module is lost. The modem then disconnects from the network to which it was optionally previously connected. This information is raised to the application software, which triggers a reset of the modem (or at the very least of its interface with the subscriber identification module).

b.3. Once the modem has been initialized, the application software queries the modem to know the state of the subscriber identification module connected to the interface of the modem, in this case the second module. The modem indicates in return whether the module is operational, whether it is blocked, whether a PIN or PUK code is necessary, or whether there is no subscriber identification module.
If the second subscriber identification module is operational, the modem can, using the information contained in the second module (identifier of the operator, network, roaming, etc.) connect to the identified communication network and operate normally.
If no module is detected (for example if the second module is defective), the application software restarts the initialization of the component 102 until a module is detected (points a.2. and a.3. hereinbefore).

b.4. If the second module is removed while the device is powered on, the modem detects that communication with the second module is lost. The modem then disconnects from the network to which it was optionally previously connected. This information is raised to the application software, which triggers a reset of the modem (or at the very least of its interface with the subscriber identification module), and the modem restarts with the information contained in the first module.

The example of implementation described hereinbefore makes it possible to manage the inhibition of the first module with few components. In addition, it is provided for the inhibition of the first module and the replacement, at the interface of the first module by the second module to be able to induce, in the component 102 and/or on another component involved in managing the module, behavior leading to an initialization of the module becoming active. In the case of insertion or removal when the device is powered on, this initialization is triggered for example when the component 102 detects a loss of communication with the first module following the insertion of the second module, or even when the component 102 detects a loss of communication with the second module following the extraction of the latter.

### Second Embodiment

According to the second embodiment, the first subscriber identification module is inhibited by a hardware assembly and a software implementation.

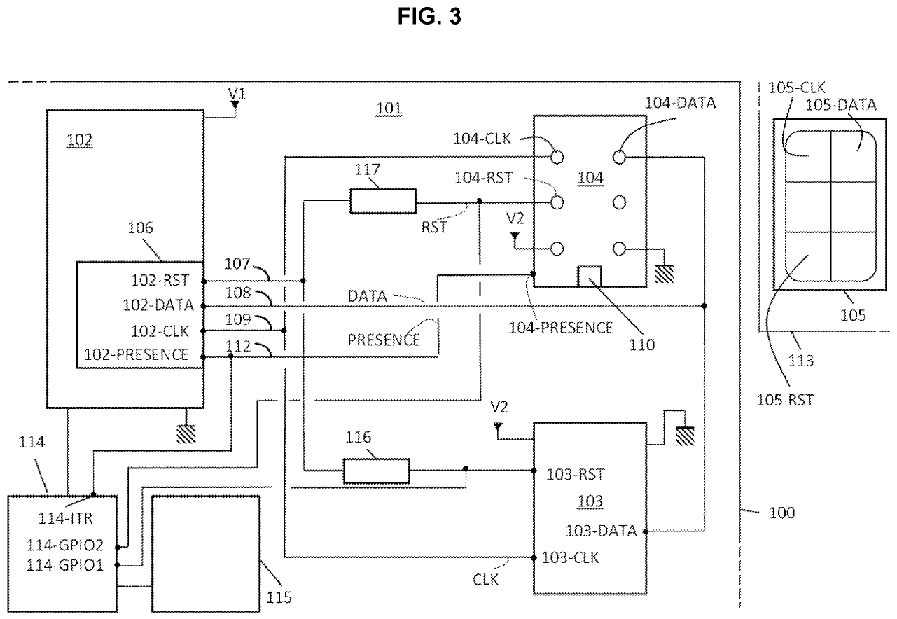

FIG. 3 is a functional block diagram of an example of a device according to the second embodiment. The device of FIG. 3 contains many of the same elements as the device illustrated by FIG. 1, aside from the elements generating the inhibition signal intended for the first module 103 on the basis of the signal indicative of the presence of the second module in the connector. The switch 111, its control line by the signal indicative of the presence of the second module and the line connecting the output of the switch to the initialization signal input 103-RST of the first module have been eliminated. Instead, the initialization signal input 103-RST of the first module is connected to an output 114-GPIO1 of the processor 114, while the input 104-RST of the second module is connected to an output 114-GPIO2 of the first module. A resistor 117, similar to the resistor 116 and having a similar role, is placed between the initialization signal output 102-RST of the component 102 and the input 104-RST of the component 104. A processor signal input 114-ITR recovers the signal indicative of the presence of the second module and thus enables the processor to know whether or not the second module 105 is inserted into the connector 104.

According to an alternative embodiment, GPIO-type signals for controlling the initialization of the modules are available directly at the component 102, their function being controlled by the processor 114.

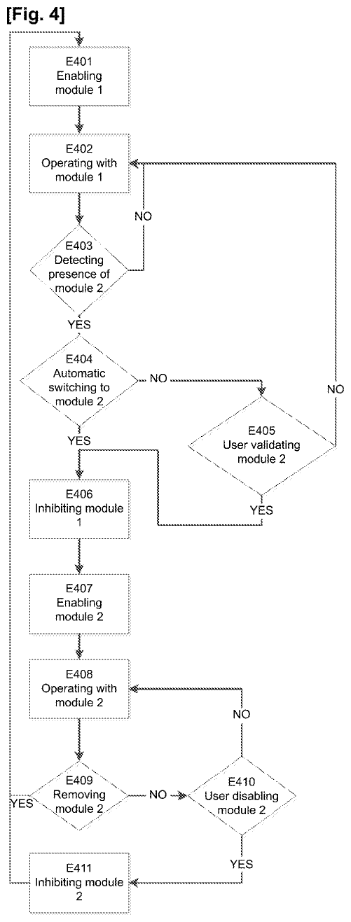

FIG. 4 is a flowchart which details an example of operation of the device of FIG. 3. According to this example, in E401, the device 100 enables the first module. The processor 114 does not force the initialization signal input of the second module to zero—the first module is therefore active and the component 102 controls all the signals of the first module, including for the initialization phase of the first module. Once this phase has ended, in E402, the device operates normally with a first module. In E403, a test is performed by the processor 114 to determine whether the first module 105 is present. If the test is negative, the device continues to operate with the first module (return to E402). If the test in E403 is positive and the device is in the mode for automatically switching to the second module upon detection of its presence, a process to inhibit the first module is triggered in E406. If the test in E403 is positive and the device is not in the mode for automatically switching to the second module, switching confirmation is requested to a user of the device E405. This confirmation can be obtained in various ways, for example by displaying a yes/no choice in a window displayed on a screen connected to or an integral part of the device 100. If the switching is not confirmed, the device continues to operate with the first module (return to E402). If the switching is confirmed, the process to inhibit the first module is triggered in E406. In particular, the processor forces the initialization signal input of the first module to zero by generating an adequate signal on the output 114-GPIO1. The second module is then enabled in E407—the output 114-GPIO2 is set to high impedance. The component 102 controls all the signals of the second module, including for the initialization phase of the second module. In E408, the second module is active and the device operates normally with the second module. If the processor 114 detects that the second module has been removed (positive test in E409), the processor reenables the first module (return to E401). The user may also be offered the choice to inhibit the second module without it having to be removed. In the event of a positive response (positive choice in E410), the second module is inhibited (E411). In particular, the processor forces the initialization signal input 104-RST to zero by generating an adequate voltage on 114-GPIO2, then returns to enabling the first module (return to E401). If the second module is not removed and the user does not choose to disable this module, the device continues to operate with the second module (return to E408).

The device of FIG. 3 allows the user to control the switching between the first module and the second module.

For example, according to one operating mode of the device, the user can choose when to switch from the first module to the second module, which is not automatic when the second module is inserted into the connector. According to one operating mode of the device, the user can choose to reenable the first module even when the first module is still present in the connector. The device may also be programmed to operate in automatic switching mode, if so desired. According to other embodiments not shown, it is possible to provide automatic switching when the second module is inserted and/or when it is extracted.

According to one alternative embodiment, the device comprises multiple fixed modules and not only one. The insertion of a module into a connector of the device then inhibits all of the fixed modules.

Various advantages have been described in the foregoing. A specific embodiment may have only one or more of these advantages, but not necessarily all the advantages.

The inhibiting circuit may comprise one or more electronic components and/or one or several processors or controllers executing suitable software code.

### REFERENCE SIGNS

100—Device
101—Printed circuit board
102—Component with interface for subscriber identification module
102-RST—Initialization signal output
102-DATA—Data input/output
102-CLK—Clock signal output
102-PRESENCE—Second module presence signal input
102-GPIO1—Inhibition signal output
103—First module
103-RST—Initialization signal input
103-DATA—Data input/output
103-CLK—Clock signal input
104—Connector for second module
104-RST—Initialization signal input
104-DATA—Data input/output
104-CLK—Clock signal input
105—Second module
105-RST—Initialization signal input
105-DATA—Data input/output
105-CLK—Clock signal input
106—Interface for subscriber identification module
107—Initialization signal line/bus
108—Data line/bus
109—Clock signal line/bus
110—Module presence detector
111—Switch
112—Second module presence signal line
113—Support
114—Processor
114-ITR—Presence-indicating signal input
114-GPIO1—First module inhibition signal output
114-GPIO2—Second module inhibition signal output
115—Memory
116—Resistor
117—Resistor

1. A device comprising:
an interface for a subscriber identification module;
a first subscriber identification module connected to said interface;
a connector suitable for connecting a second subscriber identification module to said interface when the second module is present in the connector;
a presence detector configured to generate a presence signal of the second module in the connector;
an inhibiting circuit for inhibiting the first module according to the presence signal, the device being configured to operate with the second module when the first module is inhibited,
characterized in that the inhibiting circuit is configured to inhibit a module by setting a data input/output of said module to a high impedance state, by applying a signal corresponding to an active state to an initialization signal input of the module to be inhibited.

2. The device according to claim 1, including:
a data bus interconnecting a data input/output of the interface, the input/output of the first module and an input/output of the connector which functionally cooperates with a data input/output of the second module when the second module is present in the connector;
a clock signal bus interconnecting a clock signal output of the interface, a clock signal input of the first module and an input of the connector which functionally cooperates with a clock signal input of the second module when the second module is present in the connector.

3. The device according to claim 1, wherein the inhibiting circuit comprises a circuit controlled by the presence signal to automatically inhibit the first module when the second module is present in the connector, the device then operating with the second module via said interface.

4. The device according to claim 3, wherein the circuit is controlled by the presence signal to automatically disinhibit the first module when the second module is removed from the connector, the device then operating with the first module via said interface.

5. The device according to claim 3, wherein:
an initialization signal output of the interface is connected to a first input of the connector, the connector being suitable for connecting the first input to an initialization signal input of the second module when the second module is present in the connector;
a resistor is connected between the initialization signal input of the second module and the initialization signal output of the interface, the resistor being suitable for allowing said interface to
control an initialization of the second module when it is present in the connector and the first module is inhibited; and
control an initialization of the first module when the second module is not present in the connector and the first module is not inhibited.

6. The device according to claim 1, wherein the inhibiting circuit comprises a processor receiving the presence signal, the processor being configured to selectively inhibit and disinhibit, respectively, one of the first and second modules, and to disinhibit and inhibit, respectively, the other one of the first and second modules, when the second module is present in the connector, the device being configured to operate with the disinhibited module.

7. The device according to claim 6, wherein the processor is configured to implement at least one of:
a first mode wherein the first module is automatically inhibited in the case where the second module is present in the connector and automatically disinhibited in the case where the second module is removed from the connector;
a second mode wherein, when the second module is present in the connector, the first module is inhibited following receipt of a confirmation from a user and disinhibited automatically in the case where the second module is removed from the connector, or on receipt of a command from a user.

8. A method performed by a device comprising an interface for subscriber identification module; a first subscriber identification module connected to said interface; a connector suitable for connecting a second subscriber identification module to said interface when the second module is present in the connector; a processor and a memory including software code which, when it is executed by the processor, causes the device to carry out the method, the method comprising:
detecting the presence of the second module in the connector;
inhibiting the first module according to the presence signal; and
when the first module is inhibited, operating the device with the second module;
characterized in that the inhibition comprises setting a data input/output of the module to be inhibited to a high impedance state, by applying a signal corresponding to an active state to an initialization signal input of the module to be inhibited.

9. The method according to claim 8 comprising
selectively inhibiting and disinhibiting, respectively, one of the first and second modules;
disinhibiting and inhibiting, respectively, the other one of the first and second modules; and
operating with the disinhibited module.

10. A computer program product comprising instructions which, when the program is executed by a processor of a device, causes the device to carry out the method according to claim 8.

11. A storage medium readable by a device provided with a processor, said medium comprising instructions which, when the program is executed by a processor of a device, causes the device to carry out the method according to claim 8.
